(19) United States
(12) Patent Application Publication
(10) Pub. No.: US 2004/0245928 A1
(43) Pub. Date: Dec. 9, 2004

(54) Plasma display panel

(76) Inventor: Morio Fujitani, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/487,715

(22) PCT Filed: Jul. 3, 2003
(86) PCT No.: PCT/JP03/08466

(30) Foreign Application Priority Data
Jul. 4, 2002 (JP) 2002-195500
Jul. 12, 2002 (JP) 2002-203834

(51) Int. Cl. H01J 17/49

(52) U.S. Cl. 313/584; 313/582; 313/586

(57) ABSTRACT

A plasma display panel is provided, in which a false discharge between adjacent discharge cells is prevented, and a generation of a address discharge between a scanning electrode and a data electrode is ensured, enabling the panel to display a quality picture. An discharge cell (15) includes a recess (16) so as a dielectric layer (3) may overlap a display electrode (5); and a scanning electrode (6) and a sustain electrode (7) in which a dimension where the recess(16) overlaps the scanning electrode (6) is made larger than a dimension where the recess (16) overlaps the sustain electrode (7) An discharge area is restricted within the recess (16) for preventing a false discharge to occur between adjacent discharge cells (15), stabilizing address discharge between the scanning electrode (6) and a data electrode (11).

### TECHNICAL FIELD

This invention relates to a plasma display panel known as a display device.

### BACKGROUND ART

A plasma display panel (hereinafter, called PDP) displays a picture with a gas discharge causing ultraviolet rays and exciting a phosphor with the ultraviolet rays.

The PDP can be roughly classified into an AC type and a DC type for its driving method, and a surface discharge type and an opposing discharge type for its discharging scheme. At present, the surface discharge type with three electrodes makes a mainstream of the PDP because of its convenience for producing high-precision and large screen, and of its simplicity in manufacturing. This type comprises a front panel and a back panel oppositely faced, with the front panel having a plurality of display electrodes composed of a scanning electrode and a sustain electrode, and the back panel having a plurality of data electrode intersecting the display electrode at right angle; an discharge cell formed at the intersection of the display electrode and the data electrode; and a phospher layer deposited in the discharge cell. With this construction, the phospher layer can be made relatively thicker fitting to a color display which employs a phospher. This condition is disclosed in a non-patent related document, ‘All about plasma display’ (May 1, 1997), coauthored by Hiraki Uchiike and Shigeo Mikoshiba, Industrial Research Committee, p.p. 79, 80).

The plasma display device using the above mentioned PDP features a high displaying speed, a wide viewing angle, easy production in a large size and a higher display quality by its self-luminescence, compared to a liquid crystal panel. Because of its features, the device is particularly getting an attention among flat panel devices and is used for a variety of applications such as a display device for a public place and a display device for a family enjoying a picture in the large screen.

Meanwhile, a request for a high precision PDP of this type is growing. In order to meet the request, an arrayed pitch of the discharge cells must be narrow. When the pitch is narrowed, a problem occurs, a false discharge between the adjacent discharge cells, adversely affecting the picture display. To display a quality picture with no defect such as of no-lighting, it is necessary to securely generate a address discharge between the scanning electrode and the data electrode when the address is made for displaying the picture.

The present invention is made to overcome above problems and aims to provide a PDP, by preventing the false discharge between the adjacent discharge cells even for the high-precision PDP and securely generating the address discharge between the scanning electrode and the data electrode.

### DISCLOSURE OF THE INVENTION

A PDP in this invention includes a front panel having a plurality of display electrodes composed of a scanning electrode and a sustain electrode covered with a dielectric layer, and a back panel having a plurality of data electrodes intersecting the display electrodes at right angles. The panels are faced with each other so that an discharge space is made between them, forming an discharge cell at an intersection between the display electrode and the data electrode. In the discharge cell, the dielectric layer includes a recess overlapping the display electrode, with a dimension where the recess overlaps the scanning electrode larger than a dimension where the recess overlaps the sustain electrode.

With this structure, an discharge is restricted within the recess and a false discharge to an adjacent cell is prevented, and a address discharge between the scanning electrode and the data electrode is secured, attaining a PDP with a high display quality.

### BRIEF DESCRIPTIONS OF THE DRAWINGS

FIG. 1 is a cross-sectional perspective view of a PDP of the present invention briefly showing a structure of the PDP.

FIG. 2 is a partially magnified view of an discharge cell of a front panel of the PDP in accordance with a first exemplary embodiment of the present invention.

FIG. 3 is a cross sectional view of the front panel in accordance with the first exemplary embodiment of the present invention depicting a discharge status.

FIG. 4 is a partially magnified view of an discharge cell having other structure in the front panel of the PDP.

FIG. 5 is a partially magnified view of an discharge cell having other structure in the front panel of the PDP.

FIG. 6 is a partially magnified view of an discharge cell having other structure in the front panel of the PDP.

FIG. 7 is a partially magnified view of an discharge cell of a front panel of the PDP in accordance with a second exemplary embodiment of the present invention.

FIG. 8 is a partially magnified view of an discharge cell having other structure in the front panel of the PDP.

FIG. 9 is a partially magnified view of an discharge cell having other structure in the front panel of the PDP.

FIG. 10 is a partially magnified view of an discharge cell having other structure in the front panel of the PDP.

FIG. 11 is a partially magnified view of an discharge cell having other structure in the front panel of the PDP.

FIG. 12 is a partially magnified view of an discharge cell having other structure in the front panel of the PDP.

FIG. 13 is a partially magnified view of an discharge cell in the front panel of the PDP in accordance with a third exemplary embodiment of the present invention.

FIG. 14 is a cross sectional view of the front panel in accordance with the third exemplary embodiment of the invention depicting a discharge status.

FIG. 15 is a partially magnified view of an discharge cell of the front panel in other structure of the PDP in accordance with the third exemplary embodiment of the invention.

FIG. 16 is a partially magnified view of an discharge cell having other structure in the front panel of the PDP.

FIG. 17 is a partial magnified view of an discharge cell having other structure in the front panel of the PDP.

FIG. 18 is a partially magnified view of an discharge cell having other structure in the front panel of the PDP.

FIG. 19 is a partially magnified view of an discharge cell having other structure in the front panel of the PDP; and

FIG. 20 is a partially magnified view of an discharge cell having other structure in the front panel of the PDP.

### DETAILED DESCRIPTION OF PREFERRED EMBODIMENTS

A plasma display panel in accordance with the present invention is described hereinafter using drawings.

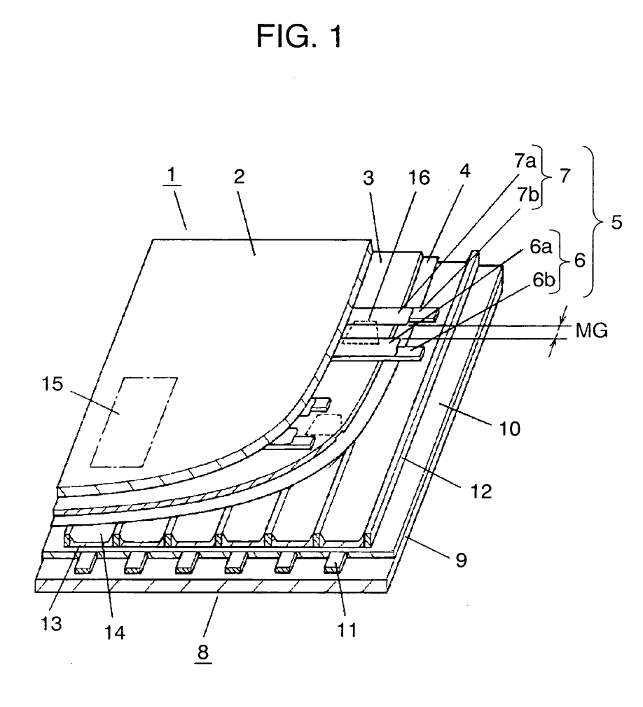

FIG. 1 is a cross-sectional perspective view of a PDP of the invention briefly showing a structure of the PDP. Front panel 1 includes a plurality of display electrodes 5 covered with dielectric layer 3 and protect film 4 a film of evaporated MgO, formed on substrate 2 made of a glass-like transparent and insulating material. Display electrode 5 is composed of scanning electrode 6 and sustain electrode 7 in a pair, with scanning electrode 6 and sustain electrode 7 facing each other separated by a discharge gap MG. Scanning electrode 6 is composed of transparent electrode 6a, and of non-transparent bus electrode 6b made of metallic materials such as Cr/Cu/Cr, and Ag formed on the transparent electrode. Likewise, sustain electrode 7 is composed of transparent electrode 7a and of non-transparent bus electrode 7b of metallic materials such as Cr, Cu and Ag formed on the transparent electrode.

Back panel 8 includes a plurality of data electrodes 11 covered with dielectric layer 10, formed on substrate 9 a glass-like insulating material. Between electrodes 11 on dielectric layer 10, barrier rib 12 in a stripe shape is interposed in parallel with data electrodes 11. On dielectric layer 10 and on a side of barrier rib 12, phosphor layer 13 is deposited in a stripe shape. Front panel 1 and back panel 8 are placed facing each other putting discharge space 14 between them and scanning electrode 6 and sustain electrode 7 intersect data electrode 11 at right angles. In discharge space 14, at least one of rare gases including helium, neon, argon and xenon is enclosed as a discharge gas. Discharge space 14, formed at the intersection where data electrode 11 separated by barrier ribs 12 crosses scanning electrode 6 and sustain electrode 7, acts as discharge cell 15.

### FIRST EXEMPLARY EMBODIMENT

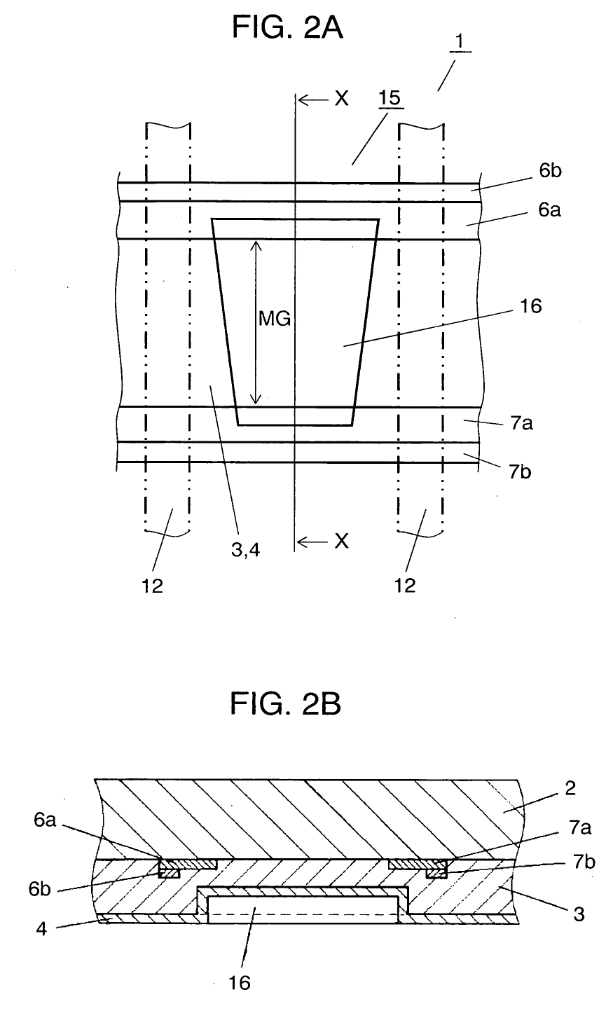

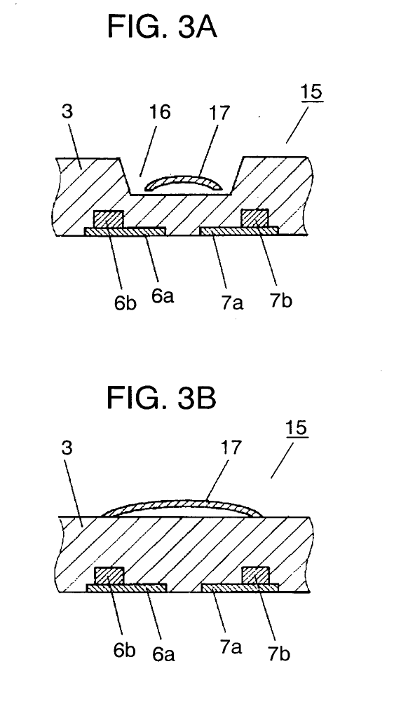

FIG. 2 is a partially magnified view of an discharge cell of a front panel of the PDP according to exemplary embodiment 1 of the present invention, FIG. 2A is a plan view of the PDP viewed from a side of an discharge cell, FIG. 2B is a cross sectional view taken along the line X-X marked with an arrow, and FIG. 3 is a cross sectional view of the front panel according to exemplary embodiment 1 of the invention depicting a discharge status.

As shown in FIG. 2A and 2B, in each discharge cell 15, dielectric layer 3 partially overlaps scanning electrode 6 and sustain electrode 7 forming display electrode 5, and includes recess 16 concaved toward substrate 2.

In exemplary embodiment 1, recess 16 is wide in its shape where the recess overlaps scanning electrode 6, and a dimension where recess 16 overlaps the scanning electrode 6 is made larger than a dimension where recess 16 overlaps sustain electrode 7. A position where barrier rib 12 contacts front panel 1 is shown by two dots chain lines.

As shown in FIG. 2A and 2B, in discharge cell 15, thickness in dielectric layer 3 is different between a area having recess 16 and a rest of area, with a different electrostatic capacity as a condenser and a different discharge voltage. Because recess 16 having a thinner dielectric layer 3 has a larger electrostatic capacity easily storing an electric charge at its bottom, a discharge voltage is lower and the discharge is readily generated and maintained. Whereas, in the area other than recess 16, the electrostatic capacity is smaller storing less electric charge, so that the discharge voltage higher and generation and maintenance of the discharge are restrained.

Namely, as shown in FIG. 3A, when recess 16 according to exemplary embodiment 1 exists in discharges cell 15, discharge 17 is restricted within recess 16 in discharge cell 15. Whereas, as shown in FIG. 3B, when recess does not exist, discharge area expands as is shown by discharge 18 causing an abnormal discharge leaking out to adjacent discharge cell 15. The abnormal discharge can thus be controlled in exemplary embodiment 1.

Moreover, in exemplary embodiment 1, because the dimension where recess 16 overlaps scanning electrode 16 is made larger than the dimension where recess 16 overlaps sustain electrode 7, a address discharge which is made for displaying a picture in the PDP is reliably generated between scanning electrode 6 and data electrode 11, improving quality of picture display.

Still more, because the discharge area is restricted within recess 16 as mentioned, and recess 16 is formed inside barrier ribs 12 as shown in FIG. 2A, generation of an discharge near barrier rib 12 is prevented. As a result, a problem—barrier rib 12 is electrically charged by the discharge and is etched with its ion-impact, and the etched substance of barrier rib 12 falls and piles on phospher layer 13 deteriorating performance of phosphor layer 13—is prevented.

Furthermore, as shown in FIG. 2A, because a side face of recess 16 is deposited with protection film 4 of MgO, a surface dimension of emitting electrons is increased, enabling to increase an emitted amount of electrons per discharge cell 15.

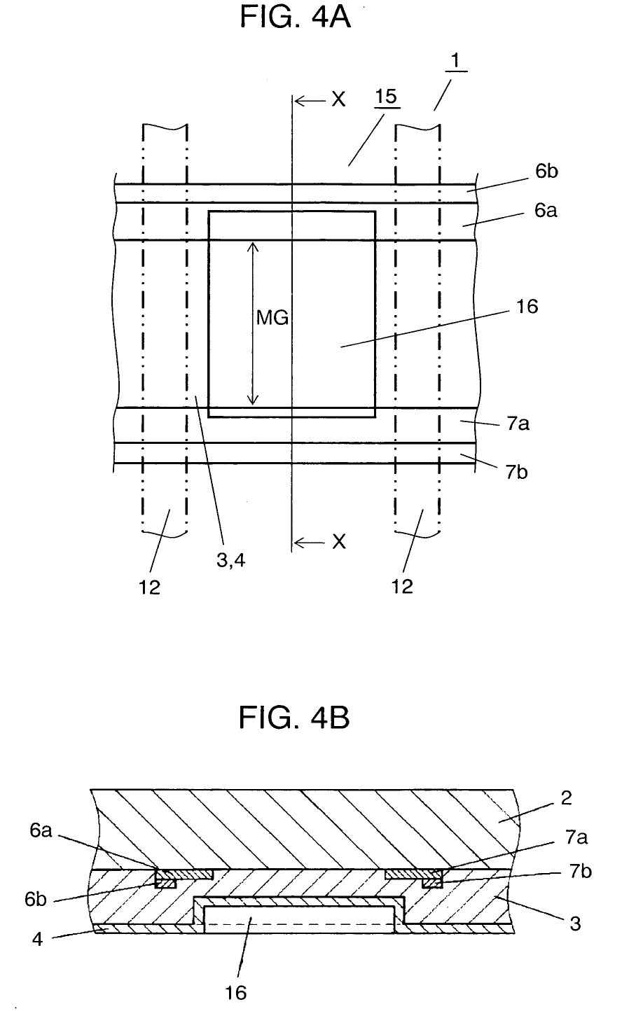

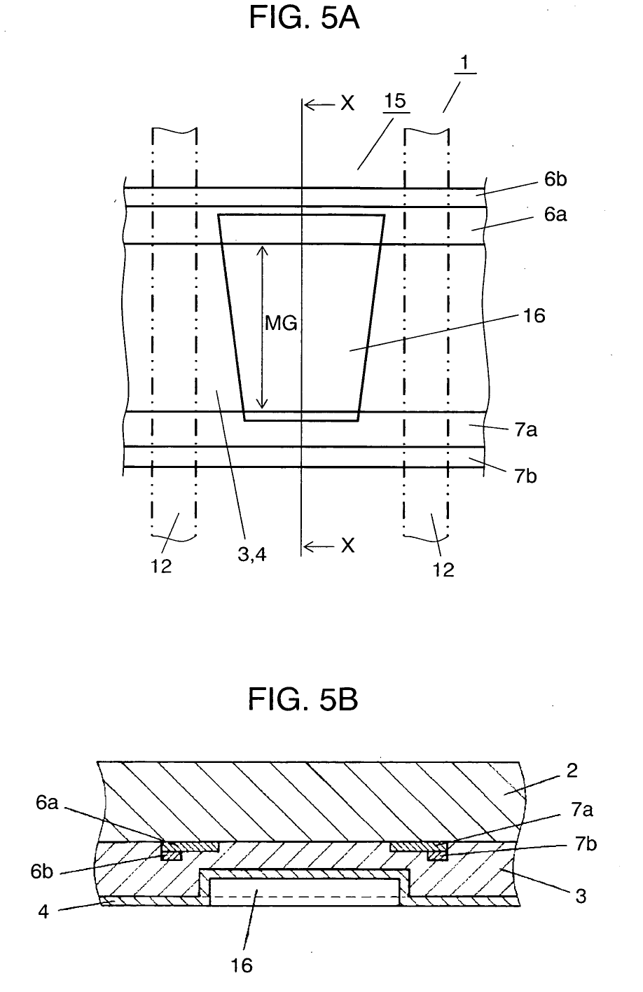

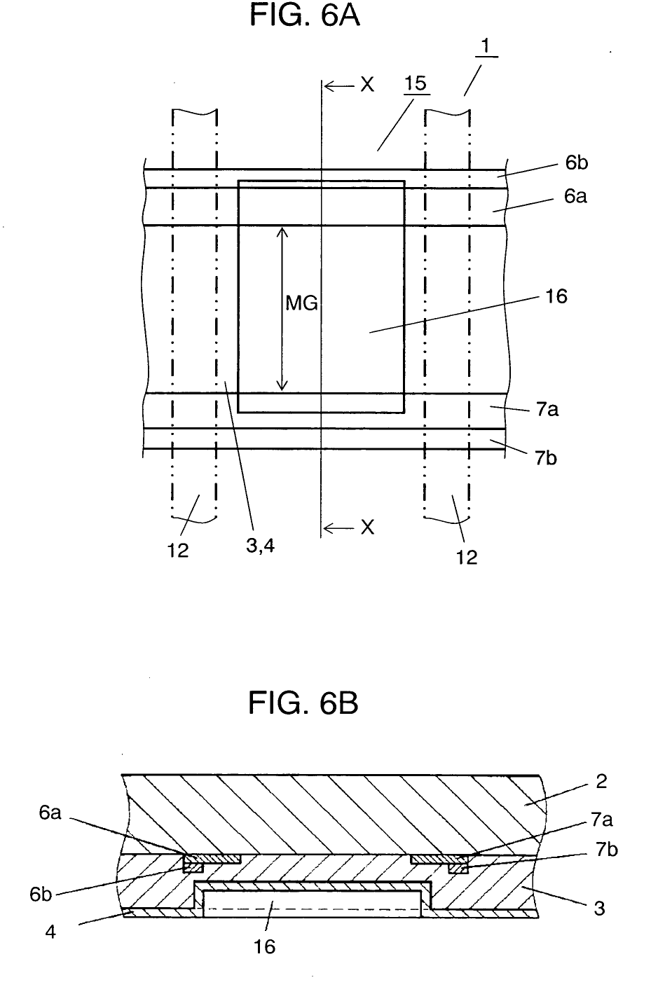

FIGS. 4, 5 and 6 are partially magnified views of an discharge cell in the front panel of the PDP in other structures according to exemplary embodiment 1. In the structure shown in FIG. 4, recess 16 in discharge cell 15 is shifted to scanning electrode 6. In the structure shown in FIG. 5, recess 16 is expanded where the portion overlaps scanning electrode 6 over and above the structure as shown in FIG. 4. It is also possible, as is shown in FIG. 6, to overlap recess 16 with bus electrode 6b of scanning electrode 6 yet to overlap only with transparent electrode 7a of sustain electrode 7. In this case, because bus electrode 6b has a better electrical conductivity than transparent electrode 6a does, dielectric layer 3 on scanning electrode 6 is electrically much charged, securely the address discharge to occur during a address period. Consequently, the false discharge between adjacent discharge cells 15 is further avoided and the picture display quality is further improved. This effect can be further augmented by expanding an opening portion of recess 16 overlapping scanning electrode 6.

### SECOND EXEMPLARY EMBODIMENT

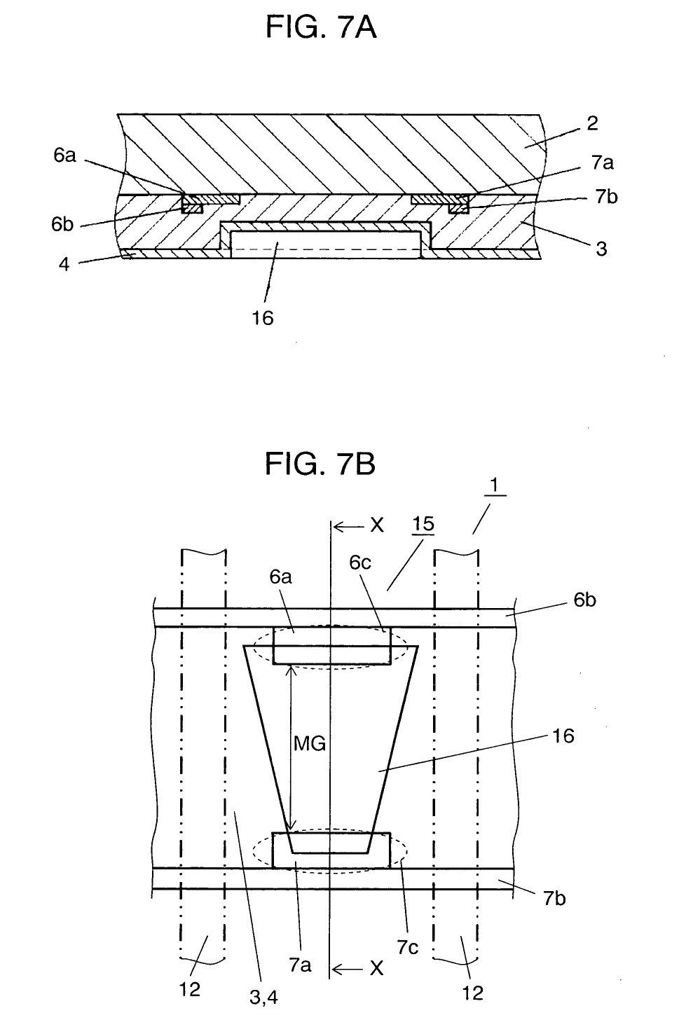

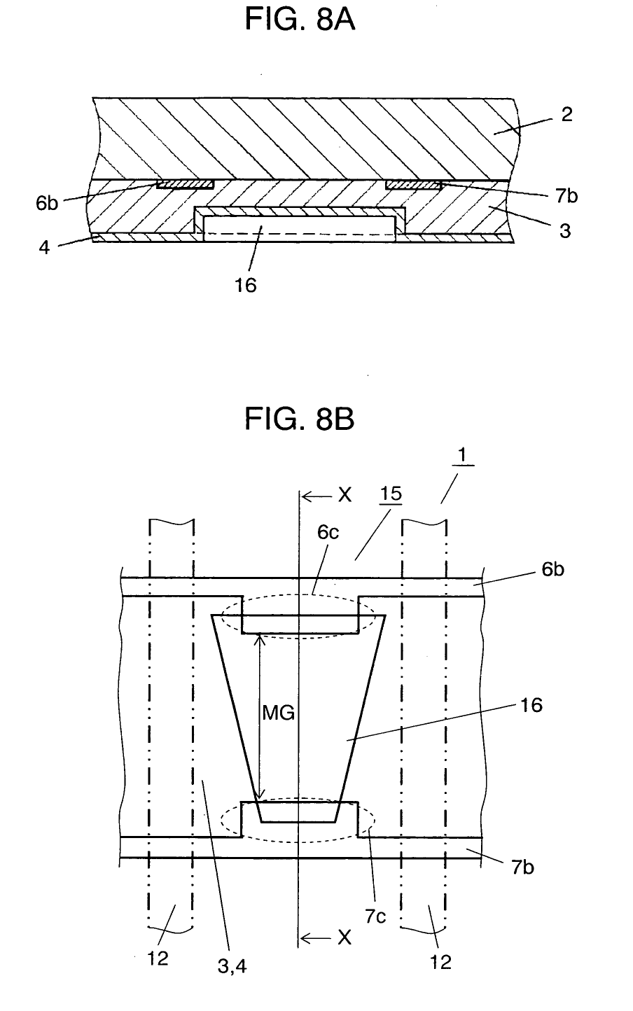

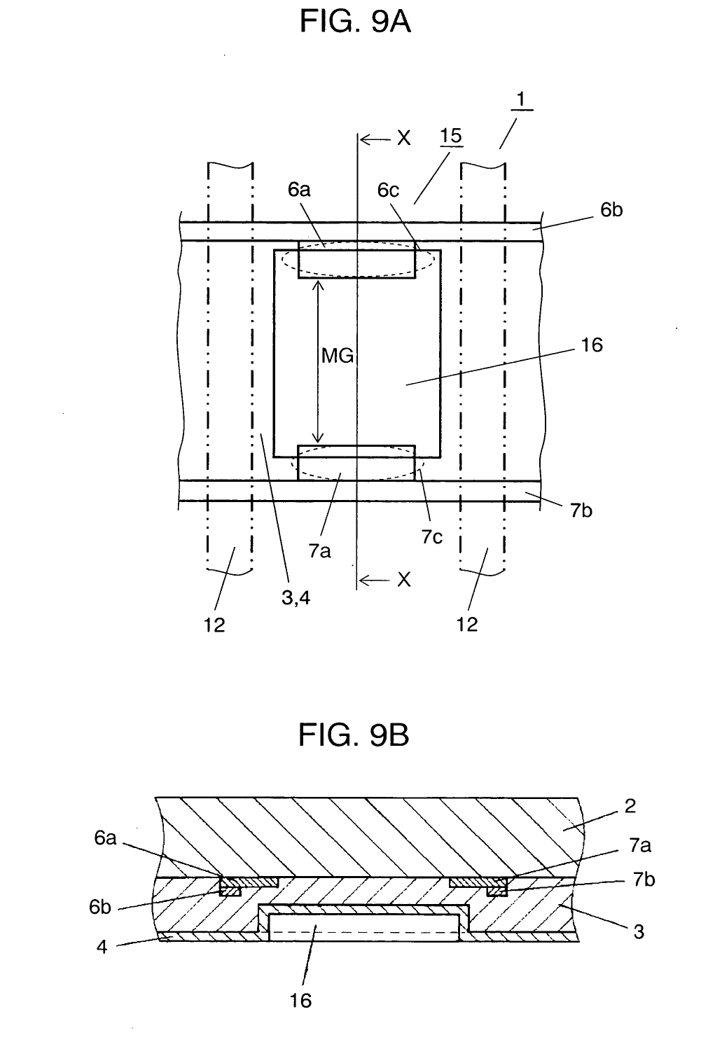

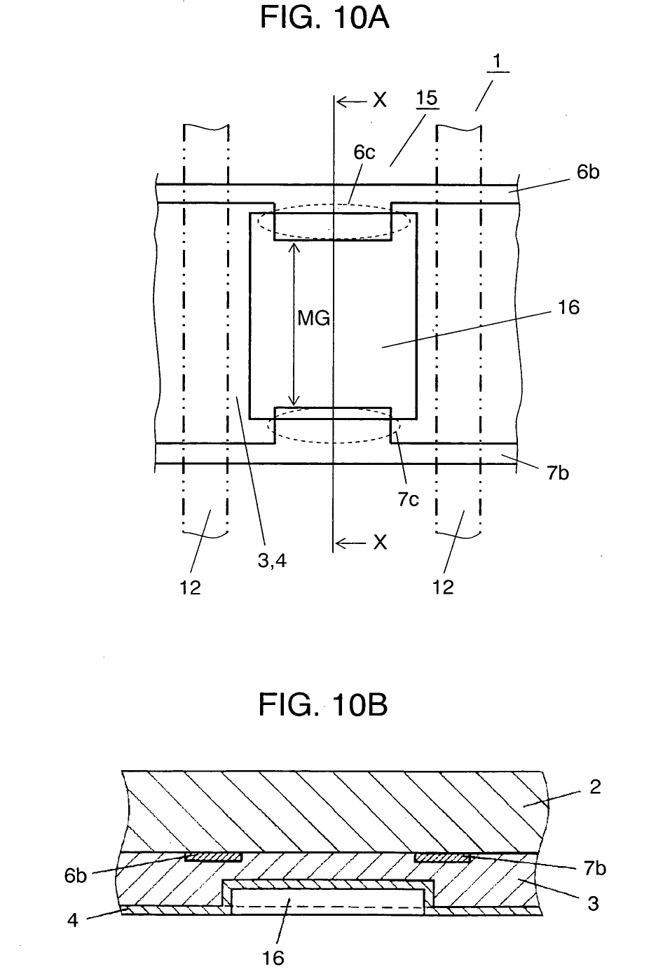

FIGS. 7 to 12 are partially magnified views of a discharge cell of the front panel of a PDP according to exemplary embodiment 2 of the present invention. In discharge cell 15 according to exemplary embodiment 2, protrusion 6c and 7c are respectively provided to scanning electrode 6 and sustain electrode 7, facing each other and separated by a discharge gap MG. In FIGS. 7 and 8, recess 16 is made so as to overlap opposing protrusions 6c and 7c, and a portion of recess 16 to overlap scanning electrode 6 is made larger. In FIGS. 9 and 10, a position of recess 16 in discharge cell 15 is shifted toward scanning electrode 6, and a dimension where recess 16 overlaps scanning electrode 6 is made larger than that of where the recess overlaps sustain electrode 7. With these structures, because an discharge area in discharge cell 15 is additionally controlled by protrusions 6c and 7c, an abnormal discharge between adjacent discharge cells 15 and an discharge near barrier rib 12 are much securely controlled.

In FIGS. 7 and 9, because protrusion 6c and 7c are composed of transparent electrode 6a and 7a, luminescence of phospher layer 13 is effectively permeated. If protrusion 6c and 7c are composed only of bus electrode 6b and 7b but eliminating transparent electrode 6a and 7a as shown in FIGS. 8 and 10, formation of display electrode 5 is easy. In addition to it, because bus electrode 6b and 7b are made of metallic material having a better electrical conductivity than that of transparent electrode 6a or 7a, an electric charge with respect to recess 16 is easily accumulated, and control of the discharge area in discharge cell 15 is further secured.

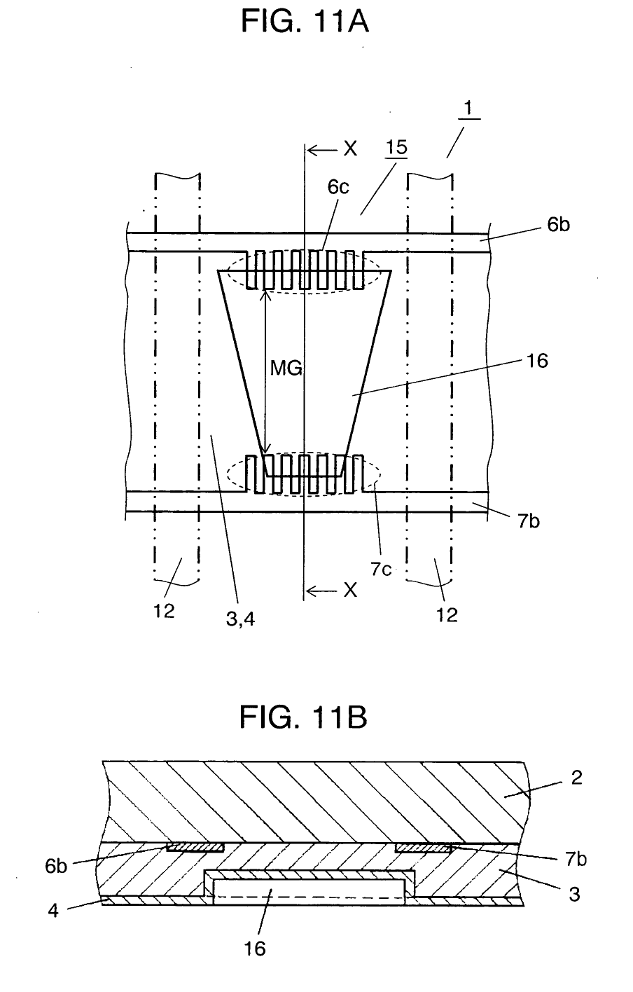

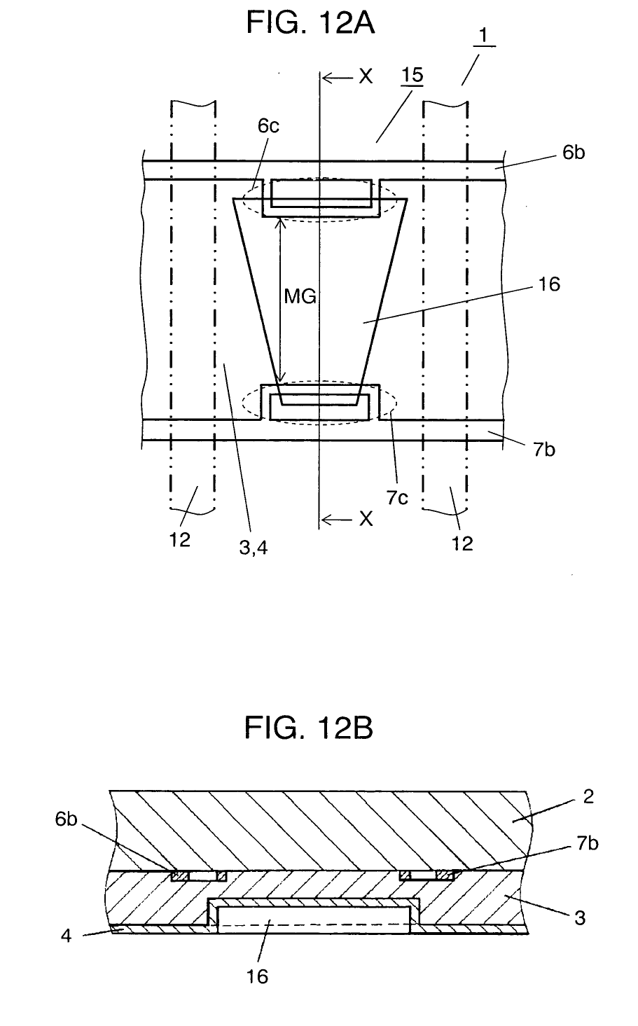

Protrusion 6c and 7c can be a comb-shape having multiples of forks as illustrated in FIG. 11, or can be a hollow shape as illustrated in FIG. 12. With these shapes, a dimension of protrusion 6c or of 7c can be reduced without changing a distance of the discharge gap MG. Therefore, even if protrusion 6c and 7c are composed of non-transparent bus electrode 6b and 7b, transparency of the luminescence from phospher layer 14 is compensated. If the dimension of the electrodes is reduced, discharge current can be controlled; therewith power consumption can be reduced.

### THIRD EXEMPLARY EMBODIMENT

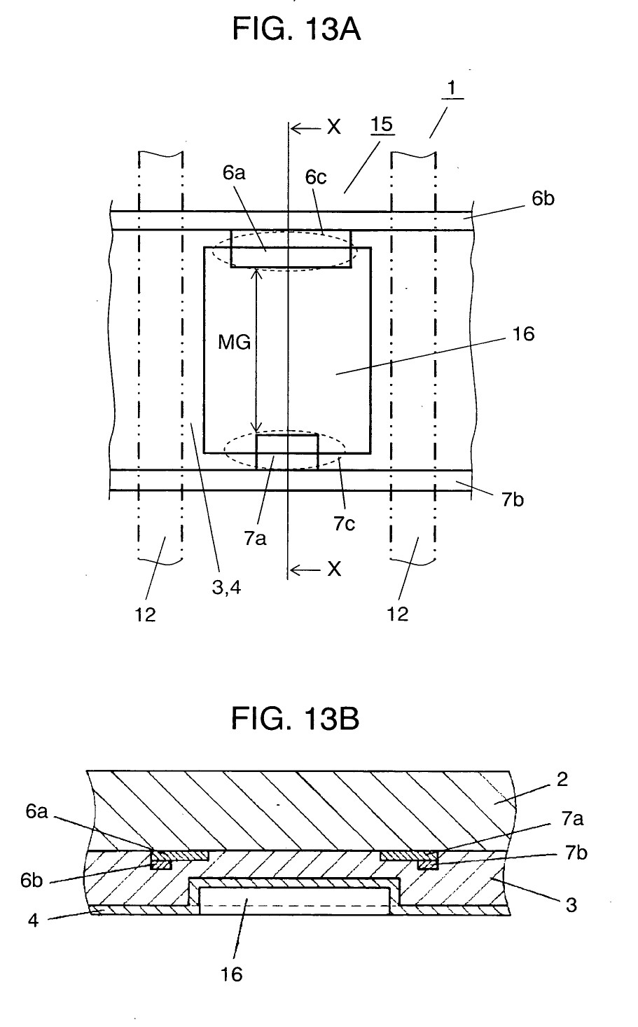

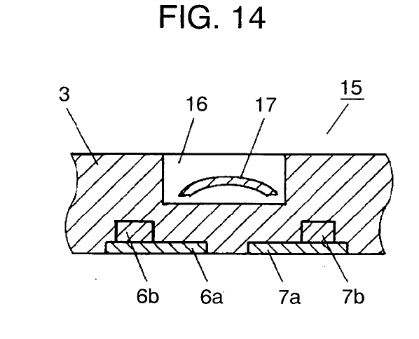

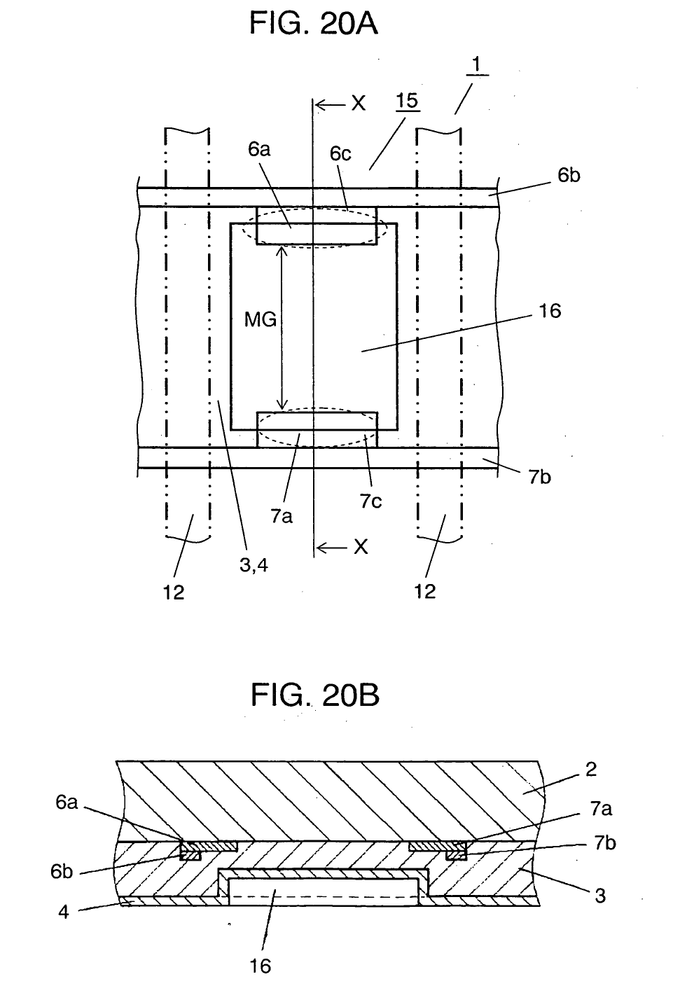

FIG. 13 and FIGS. 15 to 20 are partially magnified views of a discharge cell of the front panel of the PDP in other structure according to exemplary embodiment 3 of the present invention. FIG. 14 is a cross sectional view of the front panel according to exemplary embodiment 3 of the invention depicting a discharging status.

In discharge cell 15 in exemplary embodiment 3, protrusions 6c and 7c are respectively provided to scanning electrode 6 and sustain electrode 7 facing each other and separated by a discharge gap MG, and protrusion 6c and 7c have a different dimension.

In discharge cell 15 in FIG. 13, scanning electrode 6 and sustain electrode 7 respectively includes protrusion 6c and protrusion 7c facing each other separated by the discharge gap MG. Recess 16 is constituted so as to overlap protrusion 6c and 7C, and the dimension of protrusion 6c is made larger than that of protrusion 7c. Because of this structure, a dimension where recess 16 overlaps scanning electrode 6 is larger than a dimension where recess 16 overlaps sustain electrode 7. Therefore, as shown in FIG. 14, generation and continuation of discharge 17 is restricted within a area of recess 16. An abnormal discharge between adjacent discharge cells 15 is thus prevented to occur even when a high precision PDP is produced. Herein, FIG. 14 is a cross sectional view of FIG. 13A taken along the line of X-X marked with an arrow, but protection film 4 is eliminated from being detailed.

In addition to it, by making the dimension of protrusion 6c larger than that of protrusion 7c, the dimension where recess 16 and scanning electrode 6 overlap is made larger than the dimension where recess 16 and sustain electrode 7 overlap. Because of it, a address discharge which is made between scanning electrode 6 and data electrode 11 for displaying a picture is secured, improving a quality of displayed picture.

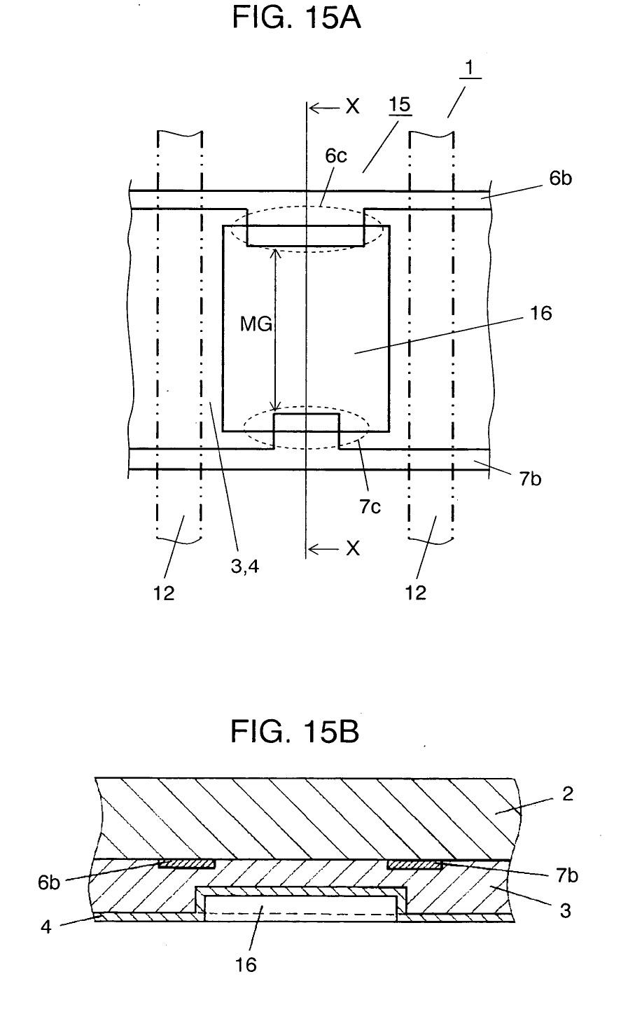

If scanning electrode 6 and sustain electrode 7 are constituted with only bus electrode 6b and 7b as shown in FIG. 15, a cost for forming electrode 5 is reduced. Furthermore, because bus electrode 6b and 7b are made of metallic material having a better electrical conductivity than transparent electrode 6a and 7b do, an electric charge is easily accumulated in recess 16, further ensuring the discharge area to be restricted within discharge cell 15.

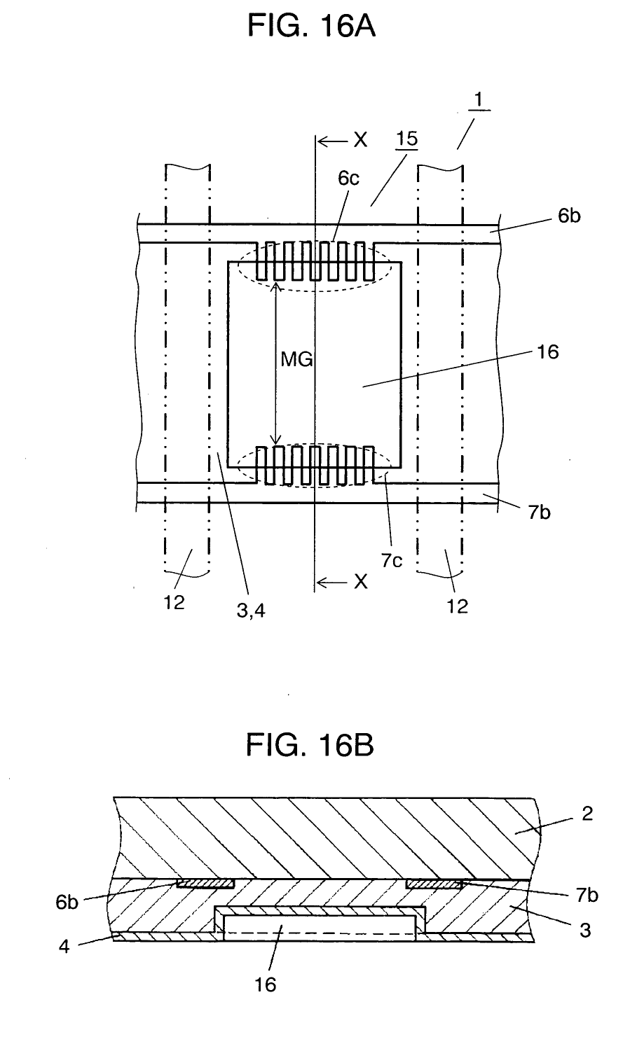

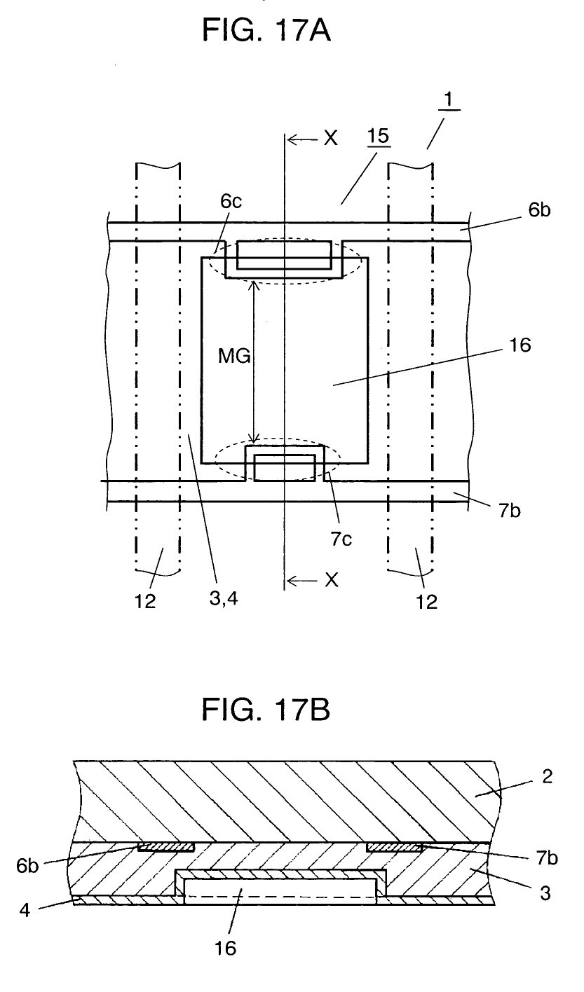

Protrusion 6c and 7c can be made into a comb-shape having multiples of forks as shown in FIG. 16, or into a hollow shape as shown in FIG. 17. With these structures, the dimensions of protrusion 6c and 7c are reduced without the distance of discharge gap MG being changed, therewith a transparency for the luminescence from phospher layer 14 is compensated. Because the dimension of the electrode is reduced, discharge current is reduced and power consumption is reduced.

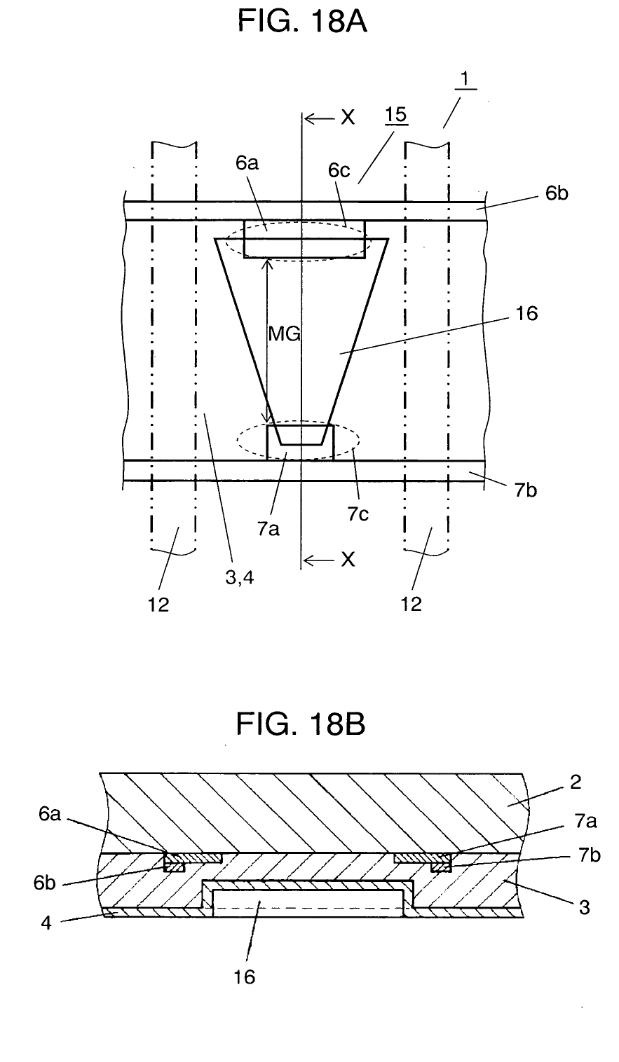

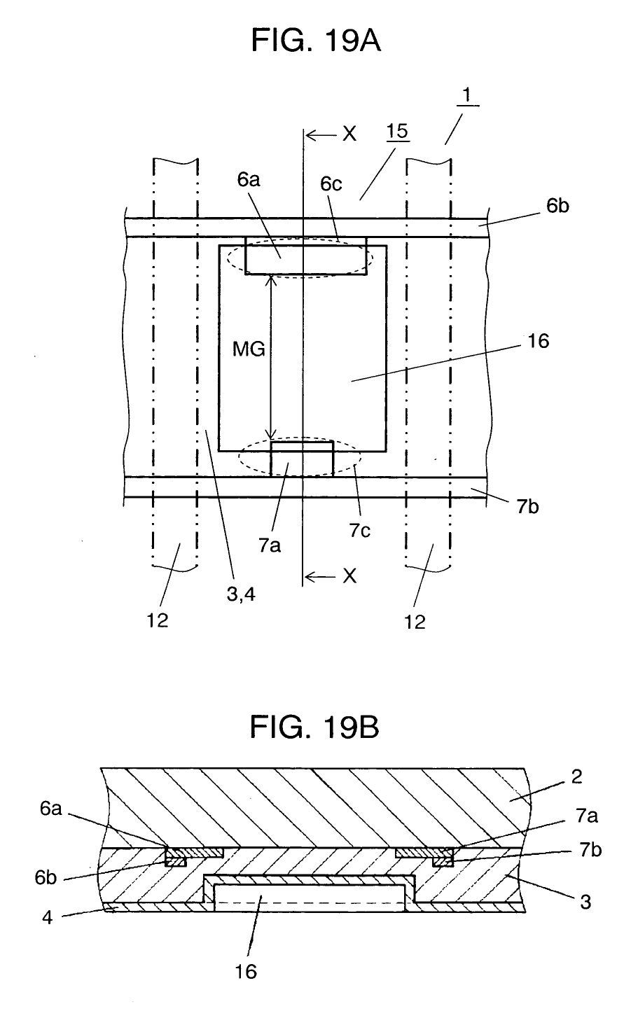

A shape of recess 16 can be made different between a side for scanning electrode 6 and a side for sustain electrode 7, in addition to the dimension of protrusion 6c and 7c being changed. Namely, the shape of recess 16 can be made larger at the side for scanning electrode 6 but narrower at the side of the sustain electrode 7 as shown in FIG. 18, or recess 16 can be shifted toward scanning electrode 6 as shown in FIG. 19. It is further preferable, by constituting the cell like in these instances, to make the dimension where recess 16 overlaps scanning electrode 6 larger than the dimension where recess 16 overlaps sustain electrode 7.

Another structure is possible to make protrusion 6c larger than protrusion 7c by increasing an amount of it but keeping a width identical with the other. With this structure, a similar effect is obtained.

For attaining a high efficiency of PDP, a method of increasing a partial pressure of Xe of a discharge gas is generally known. A mixed gas of Xe with Ne and/or He with the partial pressure of 5 to 30% of Xe is used for instance as the discharge gas. However, when the partial pressure of Xe is raised, a discharge voltage is resultantly increased, and radiation of ultraviolet rays is also increased, easily saturating brightness. To overcome these problems, a film of dielectric layer 3 is made thicker in a conventional method for decreasing capacitance of dielectric layer 3 therefore decreasing an amount of the electric charge generated per pulse. However, as the thickness of dielectric layer 3 is increased, transparency ratio of dielectric layer 3 is decreased, falling out the efficiency. When the thickness of dielectric layer 3 is increased, a problem occurs, an increase of the discharge voltage.

In the present invention, however, by properly selecting a shape and a size of recess 16 and of display electrode 5, the discharge area is restricted and the discharge current is voluntarily controlled, thereby saturation of brightness caused by the high partial pressure of Xe is controlled. Namely, with the present invention, the discharge current necessary for the PDP with the high partial pressure of Xe is controlled only by the dielectric material without changing a circuit or a driving method.

### INDUSTRIAL APPLICABILITY

The present invention provides a plasma display panel preventing a false discharge to occur between adjacent discharge cells even for a high precision type, and securely generating a address discharge between a scanning electrode and a data electrode, thereby displaying a quality display picture.

### Reference Marks in the Drawings

1. Front panel

2,9. Substrate

3,10. Dielectric layer

4. Protection film

5. Display electrode

6a, 7a. Transparent electrode

6b, 7b. Bus electrode

6c, 7c. Protrusion

7. Sustain electrode

10. Back panel

11. Data electrode

12. Barrier rib

13. Phospher layer

14. Discharge space

15. Discharge cell

16. Recess

1. A plasma display panel comprising:
A front panel including a plurality of display electrodes composed of a scanning electrode and a sustain electrode, and a dielectric layer covering the display electrodes; and
a back panel including a plurality of data electrodes placed crossing over the display electrode at right angle,
wherein, the front panel and the back panel are disposed facing each other so as an discharge cell is made at an intersection between the display electrode and the data electrode:
wherein, in the discharge cell, the dielectric layer has a recess overlapping the display electrode and a dimension where the recess overlaps the scanning electrode is made larger than a dimension where the recess overlaps the sustain electrode.

2. The plasma display panel as defined in claim 1,
wherein the recess is enlarged where the recess overlaps the scanning electrode.

3. The plasma display panel as defined in claim 1,
wherein, the recess is formed shifted toward the scanning electrode, in the discharge cell.

4. The plasma display panel as defined in claim 3,
wherein, the scanning electrode and the sustain electrode respectively includes a transparent electrode and a bus electrode made of a metallic material,
wherein, the recess is formed shifting toward the scanning electrode so as the recess may overlap the canning electrode at least with the bus electrode but overlaps the sustain electrode only with the transparent electrode.

5. The plasma display panel as defined in claims 1
wherein, the scanning electrode and the sustain electrode respectively includes a protrusion being faced each other,
wherein, the respective protrusion overlaps the recess.

6. The plasma display panel as defined in claim 5,
wherein, a dimension of the protrusion of the scanning electrode is larger than a dimension of the protrusion of the sustain electrode.

7. The plasma display panel as defined in claim 5,
wherein, the protrusion is one of in a comb shape with a plurality of forks and in a hollow shape.

8. The plasma display panel as defined in claim 6,
wherein, the protrusion is in one of a comb shape with a plurality of forks and a hollow shape.

9. The plasma display panel as defined in claim 1,
wherein, one of gas of Xe—Ne—He mixture and Xe—He mixture is enclosed in an discharge space,
wherein, a partial pressure of Xe is in 5 to 30%.
